(19) United States
(12) Patent Application Publication
(10) Pub. No.: US 2026/0350495 A1
(43) Pub. Date: Nov. 5, 2026

(54) Vehicle-Based Services and Hailing Methods

(71) Applicant: Chian Chiu Li, Fremont, CA (US)

(72) Inventor: Chian Chiu Li, Fremont, CA (US)

(21) Appl. No.: 19/738,520

(22) Filed: Jul. 12, 2026

Related U.S. Application Data
(63) Continuation-in-part of application No. 18/947,061, filed on Nov. 14, 2024.

(51) Int. Cl. G06Q 10/02; G06F 3/16; G06Q 30/0283; G06Q 50/47; G10L 15/22

(52) U.S. Cl. CPC G06Q 10/02; G06F 3/167; G06Q 30/0283; G06Q 50/47; G10L 15/22; G10L 2015/223

(57) ABSTRACT

System and method for vehicle-based services and hailing a vehicle. A same gender option is provided for requesting another occupant being the same gender. Hailed vehicles are arranged to provide cooking, massage, medical, and parcel-delivery services. Using a ship-to-vehicle method, a parcel is delivered to an occupant of a hailed vehicle. In one aspect, a ship-to-vehicle option is presented in a purchasing interface. In another aspect, a notification is presented in a vehicle-hailing interface when a parcel is ready for delivery. Options are also provided for a user to select a trip segment as a parcel-delivery window.

### CROSS REFERENCE TO RELATED APPLICATION

This is a continuation-in-part of U.S. application Ser. No. 18/947,061, filed Nov. 14, 2024, which is a continuation-in-part of U.S. application Ser. No. 17/700,324, filed Mar. 21, 2022, which is a continuation-in-part of U.S. patent application Ser. No. 15/903,043, filed Feb. 23, 2018.

### FIELD OF INVENTION

This invention relates to vehicle-based services, more particularly to vehicle-based parcel-delivery services and parcel transfer methods. This invention also relates to vehicle hailing methods.

### BACKGROUND OF THE INVENTION

Autonomous vehicle (also known as driverless or self-driving vehicle) is a vehicle capable of sensing and navigating around the vehicle's surroundings and travelling autonomously to a destination without user input. It represents a great advance in the transportation industry.

When autonomous vehicles become widely available, many users may rely on self-driving taxis or self-driving shared cars, instead of driving by themselves. A large number of users who frequently take an autonomous vehicle to places may create a sizable demand for certain services. For instance, when a user in a vehicle doesn't drive, the user may have time for a rest or a need to do certain things. However, current taxies or shared cars function as a transportation tool only. They rarely provide other services.

Therefore, there exists a need for certain services provided for an occupant in a vehicle, especially in an autonomous vehicle.

Currently, a user needs to submit a shipping address or delivery address before placing an online purchase order. It may be a residential address or business address. Since a user may not be at home when a parcel arrives and may not want to use a work place as a shipping or delivery address due to privacy concerns, receiving a parcel may become a concern or issue after a purchase is made. Meanwhile, when a user hails a vehicle, the exact location of the user is known to a ride-hailing company, i.e., in a hailed vehicle, and the user may stay in the vehicle for a while.

Therefore, there exist a need for a delivery method and a need to make use of a hailed vehicle.

As used herein, the word “vehicle” may indicate any form of motorized transportation. Examples of vehicles may include automobiles, drones or unmanned aerial vehicles (UAVs), flying cars, aircrafts, and ships. As used herein, the term “Service Center” may indicate a center or remote facility as a business entity or a server which is operated at Service Center. The term “check in” as used herein may mean a user logs in a system at a vehicle using info obtained from a reservation or using other suitable info. In one scenario, after a check-in process, the identity of a user may be confirmed. In another scenario, after a check-in process, the identity of a user may remain unknown. The word “parcel” as used herein may indicate any package which is sent to a user. A parcel may come from a seller and contain a product or an order which a user purchased online or at a retail store. A parcel may also include a package containing a takeout order from a restaurant. The terms “hailing (hail) a vehicle” and “hail a car” as used herein may mean an action via an app or online process performed by a user to order a vehicle for renting purpose (e.g., for a ride to go to a place) or reserve a vehicle for present or future use. There exists a need for improved methods to hail a vehicle.

### OBJECTS AND ADVANTAGES

Accordingly, several main objects and advantages of the present invention are:
a). to provide improved services for an occupant of a vehicle and improved methods for hailing a vehicle;
b). to provide such services which include cooking service, massage service, medical service, and parcel-delivery service;
c). to provide such services which enable delivering a parcel to an occupant of a hailed vehicle;
d). to provide such services which enable a ship-to-vehicle method at an e-commerce website;
e). to provide such services which present a notification in a vehicle-hailing interface when a parcel is ready for delivery;
f). to provide improved methods to transfer a parcel from a UAV to a vehicle; and
g). to provide improved methods to transfer a parcel from a vehicle to another vehicle.

Further objects and advantages will become apparent from a consideration of the drawings and ensuing description.

### SUMMARY OF THE INVENTION

In accordance with the present invention, vehicle-based services and hailing methods are provided for a user. The services include cooking a meal, massage, performing a medical checkup and treatment, and parcel delivery. With a ship-to-vehicle method, a parcel is delivered to an occupant of a vehicle. An alert icon is configured in a vehicle-hailing interface as a notification or reminder to inform a user that a parcel is ready for delivery. A ship-to-vehicle option is arranged in a purchasing interface. In addition, options are provided for a user to choose a segment of a trip as a parcel-delivery window. Further, methods are provided for transferring a parcel from a UAV to a vehicle and from a vehicle to another vehicle. Moreover, a same gender option is provided for a user to request other occupants in a vehicle being the same gender.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1-A is an exemplary diagram describing an embodiment involving a vehicle, a client system, and a server in accordance with the present invention.

FIGS. 1-B and 1-C are exemplary diagrams which depict a client system and a vehicle respectively in accordance with the present invention.

FIGS. 2 and 3 are exemplary diagrams which illustrate settings of a vehicle-hailing interface in accordance with the present invention.

FIG. 4 is a flow diagram depicting an exemplary vehicle-hailing process in accordance with the present invention.

FIG. 5 is a flow diagram depicting an exemplary vehicle-dispatching process in accordance with the present invention.

FIGS. 6 and 7 are exemplary diagrams which illustrate interface settings for selecting food services in accordance with the present invention.

FIG. 8 is an exemplary diagram which illustrates an interface for submitting shipping information in accordance with the present invention.

FIG. 9 is a flow diagram depicting an exemplary parcel-delivery process in accordance with the present invention.

FIG. 10 uses exemplary diagrams to describe steps to transfer a parcel from a UAV to a vehicle in accordance with the present invention.

FIGS. 11 and 12 show exemplary diagrams illustrating methods to use a barrier to protect the windshield of a vehicle in accordance with the present invention.

FIG. 13 is an exemplary diagram that illustrates transferring a parcel from a vehicle to another vehicle in accordance with the present invention.

FIG. 14 is another exemplary diagram that illustrates transferring a parcel from a vehicle to another vehicle in accordance with the present invention.

FIGS. 15 and 16 are exemplary diagrams illustrating methods to get consent from a user and provide options for the user to receive or refuse a parcel in accordance with the present invention.

### REFERENCE NUMERALS IN DRAWINGS

10 Processor 12 Computer Readable Medium
14 Communication Network 16 Client System
18 Vehicle 20 Processing Module
22 Database 24 Server
26 Smartphone 28 Screen
30 Button 32 Button
34 Button 36 Button
38 Button 40 Button
42 Button 44 Button
46 Button 48 Button
50 Smartphone 52 Screen
54 Button 56 Button
58 Button 60 Button
62 Button 64 Button
66 Window 68 Smartphone
70 Screen 72 Check Box
74 User Input Area 76 Window
78 Check Box 80 Check Box
81 Barrier 82 Vehicle
82A Windshield 83 Barrier
83A Sheath 84 Landing Pad
85 Vehicle 85A Transport Vehicle
86 Door 87 Connector
87A Joint 88 Parcel
89 Duct 90 UAV
91 Vehicle 91A Transport Vehicle
92 Area 93 Connector
93A Joint 94 Area
95 Duct 96 Area
97 Gripper 98 Button
200 Display 202 Message
204 Button 206 Button
208 Message 210 Button
212 Button
100-168 are exemplary steps.

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types. Wherever possible, the same reference numbers are used throughout the drawings to refer to the same or like parts.

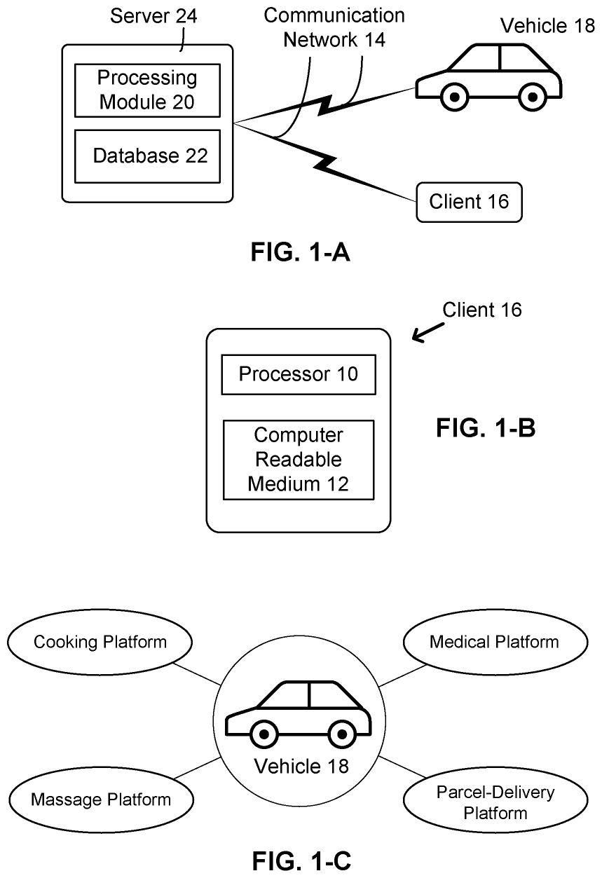

FIG. 1-A is an exemplary block diagram of one embodiment according to the present invention. A vehicle 18 and server 24 are connected via a wireless communication network 14. So are a client system 16 and server 24. Provided that server 24 is installed at Service Center. Service Center is arranged as a ride-hailing company which administers vehicles including vehicle 18 and processes hailing requests from users. The word “server” as used herein means a system or systems which may have similar functions and capacities as one or more servers. Server 24 may exemplarily be divided into two blocks, represented by a processing module 20 and database 22. Processing module 20 may include processing and communication functions. Database 22 may store vehicle service records and information, map data and geographic info of certain areas, user account information, user transaction records, etc. The database may include a cluster of memory chips and/or storage modules. In the figure, server 24 may represent a device that collects, processes, stores, and maintains information and documents, sends instructions to vehicles, transmits messages to users, executes tasks requested by users, etc.

FIG. 1-B describes client system 16 exemplarily. Client system 16 may cover a range of electronic devices and gadgets, e.g., a desktop computer, a notebook computer, a tablet computer, a smartphone, a smart watch, a virtual reality (VR) device, an augmented reality (AR) device, and the like. Client system 16 may include a processor 10 and computer readable medium 12. Processor 10 may mean one or more processor chips or systems. Medium 12 may be the main part of a storage system and include a memory hierarchy built by one or more memory chips or storage components like RAM, ROM, FLASH, or other suitable storage modules. Processor 10 may run programs or sets of executable instructions stored in medium 12 for performing various functions and tasks like surfing on the Internet, placing purchase orders, hailing a vehicle, sending and receiving emails and short messages, playing video or music, etc. Client system 16 may also include input, output, and communication components, which may be individual modules or integrated with processor 10.

In addition, client system 16 may have a display (not shown) and a graphical user interface (GUI). The display may have a liquid crystal display (LCD) screen or light emitting diode (LED) screen and may be arranged sensitive to touches, i.e., sensitive to haptic and/or tactile contact with a user. A user may use the interface to interact with online sellers, restaurant ordering systems, Service Center or server 24, and so on. Via client system 16, for instance, a user may place orders, select a shipping option, hail a vehicle, choose a vehicle-based service, and specify a trip segment for parcel delivery.

Furthermore, client system 16 may have a voice recognition mechanism to receive a user's verbal command or voice input. The system may also have a facial recognition mechanism to recognize a user. Further, the system may have a gesture detection mechanism to receive a user's gesture instructions. For VR and AR devices and some wearable devices, a virtual screen or a screen with a very small size may be arranged. A virtual screen may be part of a displaying system that doesn't have a physical screen. When it is impractical or inconvenient to touch a virtual screen or very small screen, a user may use a voice command and gesture instructions to interact with a system.

FIG. 1-C illustrates vehicle 18 and business platforms it may provide schematically. The vehicle may have various sensors (not shown) to detect an external environment and internal situation. The sensors may include cameras, a radar system, a light detection and ranging (LIDAR) system, a global position system (GPS), a speed sensor, an accelerometer, a gyroscope, an electronic compass, etc. Vehicle 18 may also have a control system. Like client system 16, the control system may have a computer processor, a storage device, a display with a touch-sensitive screen, a voice recognition mechanism, a facial recognition mechanism, and a gesture detection mechanism. It is noted that the voice, facial, and gesture recognition technologies are all mature nowadays. The control system may use the sensors to navigate vehicle 18 to a destination, implement a task submitted by an occupant, and interact with an occupant. Moreover, as shown in the figure, vehicle 18 may have business platforms which provide additional services, such as food service, massage service, medical service, and parcel-delivery service.

A cooking platform may function as a deli and a miniature kitchen. For instance, a cooking platform may have a freezer and refrigerator for food storage, an oven for baking and broiling, a frying pan for frying, a boiler for boiling or steaming, and a microwave oven for quick heating. A robotic handler may be installed inside a vehicle which may do picking, mixing, wrapping, and other kitchen jobs. Dishes which are suitable for a small vehicle may include sandwich, hamburger, pizza, hot dog, French fries, hot soup, pancake, spaghetti, etc. A vehicle's cooking platform may not only provide freshly-cooked food, but also save time for a user, as a trip to a restaurant and waiting in a line are avoided.

A massage platform may be arranged to provide massaging services for an occupant. For instance, a vehicle seat may be designed to provide massaging functions. There are massaging chairs at the market. Those chairs may be modified to fit a vehicle. Massage services may make a trip more relaxed and comfortable,

A medical platform may be designed to provide certain medical checkups, diagnosis, and treatments. For instance, certain mature medical equipment and devices may be modified and installed in a vehicle. The equipment and devices may measure an occupant's heart rate, blood pressure, body temperature, blood glucose, cardiogram, and so on. The equipment may be designed to diagnose certain diseases like cold, flu and fever and a user may use the diagnosis as a preliminary step before going to see a doctor. The equipment may also be used to perform relatively simple tasks like flu shot injection or removal of certain moles on an occupant's skin. Medical services may be desirable for some users who are concerned with their health and some users who need certain diagnosis and treatment but are reluctant to schedule an appointment at a doctor's office. As some medical services need a stable environment, a vehicle may be arranged to slow down below a given speed or stop at a place before performing a medical task. For instance, a vehicle control system may present a message on a display to an occupant. The message may be like “Vehicle will stop shortly. Be prepared for flu shot.” Then, the vehicle may stop at a stopping place or parking lot and the control system may start a medical service.

A parcel-delivery platform may be configured to receive a parcel and pass it to an occupant. After a user schedules a trip, the whereabouts of the user in a time frame may be forecasted. If Service Center has info that there is a parcel ready for delivery to the user, the center may send the parcel to a vehicle which the user will take or is riding in. Hence, the user may receive the parcel while riding in the vehicle during a journey. Currently, a shipping company has no knowledge about a recipient's location. Whether a recipient is at home, at work, at a school, or at a shopping mall, a shipping company has no information. Lack of info about a recipient's location may no longer exist for certain users when they hail a vehicle frequently. Use of a hailing request to predict a user's location in advance may not only enable secured parcel delivery, but also cause less privacy concerns, as Service Center knows it already. When such an opportunity is utilized, it makes a delivery securer than home delivery, since nobody may be at home when a parcel arrives.

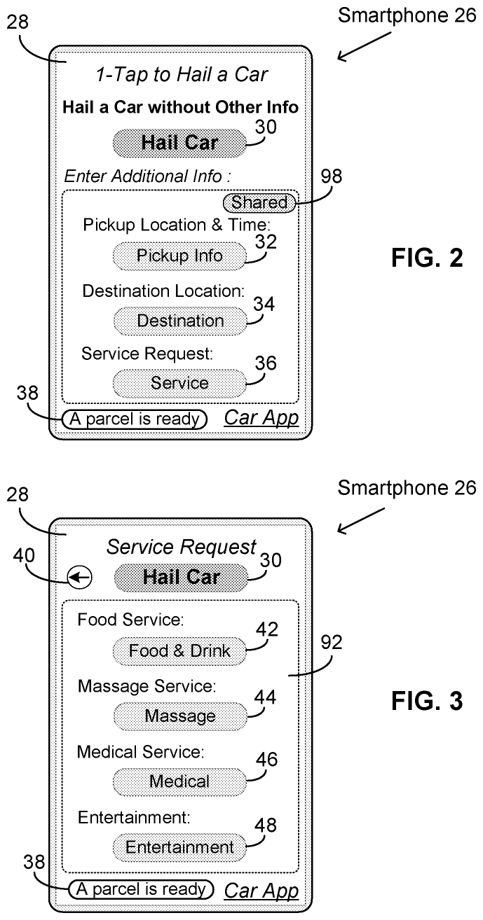

Although a service may be requested by many users, only a limited number of vehicles may be well equipped to provide it. Thus, a user may have to request a service as an extra demand during a vehicle hailing process. FIG. 2 shows an exemplary diagram of an app interface which enables service selections. Assuming that Car App is installed at a smartphone 26. The app may be provided by Service Center for hailing or reserving a vehicle. As in the figure, content items in the app interface are shown on a touch-sensitive screen 28. There are interactive elements or buttons 30, 32, 34, 36, and 98. The top portion of the interface is configured for a simple and quick hailing process which requires one action only. The first line shows a title, like a sentence “1-Tap to Hail a Car”. The second line gives a concise explanation “Hail a Car without Other Info”. Button 30 has a label “Hail Car”.

The app is designed such that a user may directly tap button 30 to complete a vehicle hailing process without submitting pickup location, pickup time, destination location, or other information. Assume that a user has an account at Service Center and enables a location option at phone 26. When the location option is enabled, phone 26 turns on GPS or uses another positioning mechanism to get its location info. After the user launches Car App, an interface like the one in FIG. 2 appears. Since the phone's location is measured constantly, the app has data of the current location. Once the user taps button 30, it prompts the app to send a message to Service Center. The message may contain at least three items: A user's account number, data of current location, and a request for a vehicle. Service Center may assume that the user needs a vehicle right now and a pickup place may be the user's current location or a nearby place if the current location is not suitable for pickup. Next Service Center may select and dispatch a vehicle to pick up the user and send a message to the user in the meantime. The message may show up in the app interface with content like when a car will come and where a pickup place will be. If the user closes the app after tapping button 30, Service Center may send the user an email or a short message containing similar information.

As a user only needs to tap button 30 after the app is launched, hailing a vehicle may become simple, quick, and convenient. Such a one-tap-to-hail-a-car process especially fits autonomous vehicles. For instance, before a taxi with a driver is dispatched, the driver's work area and work schedule have to be reviewed. Some drivers may not be available for a long trip or a trip to a specific area. On the contrary, autonomous vehicles don't have such limiting factors. They may be treated relatively equal. Therefore, an autonomous vehicle may be sent to a user without knowing destination info and without worrying about where the user will go.

When a user taps button 30 without entering other info, a hailing request is made under the assumption that the user needs a vehicle assigned to one party only. If a user wants to save money, the user may share a vehicle with one or more parties. Button 98, with an exemplary label “Shared”, may be configured in the interface as an option for a shared vehicle. The button may have similar brightness to other buttons initially. Once the button is tapped, it may be lightened, showing a request for a shared vehicle is entered. It is noted that destination info is needed for requesting a shared vehicle, as Service Center couldn't pair users without knowing whether they head for similar directions.

When a user needs a vehicle at a later time or a pickup place at another location, the user may tap button 32 to open a window or page, where the user may enter pickup time or pickup location. Otherwise, Service Center may assume that the user needs a vehicle at current time and current location. A user may also tap button 34 to open a window or page and enter destination information, such as a street address or a name of a venue. Although destination info may not be necessary in a hailing process, some users may prefer to provide the info when reserving a vehicle, instead of giving it later or after getting in a vehicle. As aforementioned, if a user wants to share a vehicle with other users, destination info is required in a hailing or reservation process.

When a user needs a service in a vehicle, the user may tap button 36. Next a service page may appear, and the user may select one among several services available in an area. In the app interface, there is also a temporary button 38, which functions as an alert sign and an interactive element. Button 38, with a label containing an alert message or notification such as “A parcel is ready”, only shows up in the interface when a parcel is available, i.e., when the app receives info from Service Center that a parcel is ready for delivery to the user. If there is no parcel ready for delivery, button 38 becomes invisible or doesn't show up in the interface. After the user taps button 38, a window or new page may appear where information about the parcel may be displayed, such as a name of the sender and the weight and dimensions of the parcel. Button 38 serves as an alert signal, notification, or reminder. It gives a recipient a notice and a relief to a certain extent and thus improves user experience.

It is noted that button 30, “Hail Car”, may be tapped at the beginning right after the app is launched or anytime afterwards. After button 30 is activated, the app may transmit a message to Service Center. The message may contain input given by a user besides info that is retrieved or collected automatically, like a user's name, account number, location, and request for hailing a vehicle. Hence, a user may tap button 30 before or after submitting pickup info, destination info, and/or a service request. Service Center may proceed differently depending upon information and requests it receives.

FIG. 3 shows another exemplary app interface according to the present invention. The interface shows up after button 36 of FIG. 2 is tapped. There are a title “Service Request” and button 30 at the top portion of the interface. As discussed, button 30 may be activated anytime to hail a vehicle without any input or with some input which a user may give via the app. A button 40 is configured beside button 30. The button is arranged for returning to a previous page. In an area 92 below button 30, there are interactive buttons 42, 44, 46, and 48 which are arranged as service options available for a user. Below area 92, button 38, still as a temporary alert sign, notification, or reminder, is configured when there is a parcel ready for delivery to a user. Again, when button 38 is tapped, another window or page may appear where information about a parcel may be displayed.

The buttons in area 92 represent services or business platforms provided for a region where a user is located in. A user may tap button 42 to enter another page and select food service options presented. Similarly, the user may tap button 44 or 46 to order a vehicle with massage or medical services. For instance, when button 44 or 46 is tapped, a page or window may appear in the interface. A list of massage or medical services may be presented. Further, a user may submit an account number at Service Center to a doctor's office and medical insurance company, and request them to forward certain notifications to Service Center. When the user opens Car App, the app may present notifications from the doctor and insurance company in the app interface. The app may also present certain medical services recommended by the doctor in the app interface. Further, when the user gets in a hailed vehicle, the control system of the vehicle, after obtaining information from Service Centre, may present the notifications and recommendations from the doctor and insurance company for the user on a display of the vehicle. After the control system detects that the user taps an item to select an in-vehicle medical service, the control system performs the medical service at a time scheduled by the control system or specified by the user. Button 48 is designed for selecting entertainment services which may include karaoke service, newly released movies, three-dimensional movies, virtual reality shows, or shows with special visual effects.

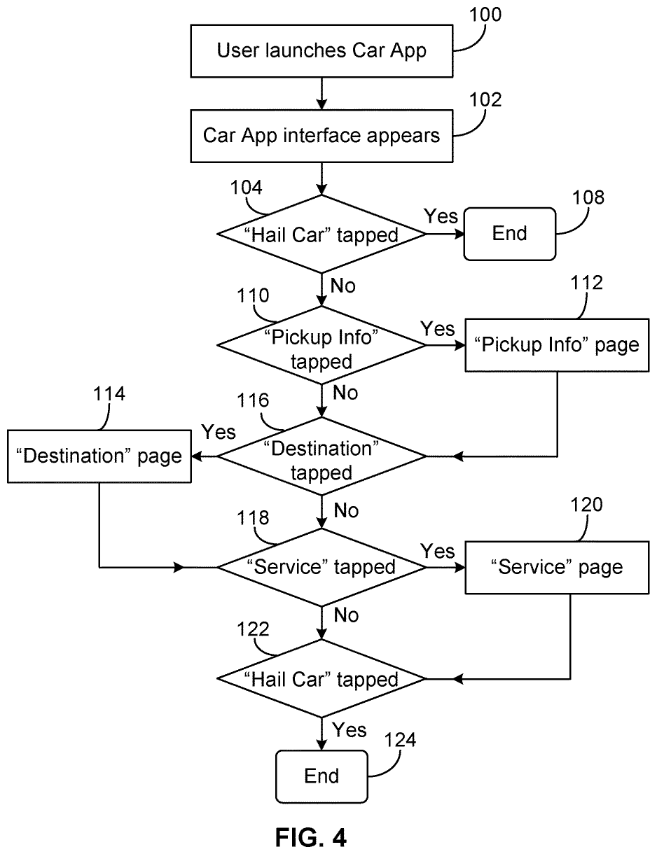

FIG. 4 is an exemplary flow diagram illustrating a vehicle hailing process according to the present invention. Assume that a user has set up an account after a registration process at Service Center. An app provided by Service Center for hailing a vehicle, e.g., Car App, is installed at an electronic device of the user. The device may be a smartphone or another smart gadget. At step 100, the user opens the app and an app interface appears at step 102. The interface may be similar to the one as shown in FIG. 2. Then, the app starts monitoring whether the user submits any input. Input from a user may include a tap on an interactive button or element or anything entered via the app interface, or a verbal command. At step 104, the user may tap a “Hail Car” button (e.g., button 30) to hail a vehicle directly and the hailing process may end at step 108. As aforementioned, the user only needs to tap the “Hail Car” button to hail a vehicle. If the user doesn't tap the “Hail Car” button, the hailing process continues. At step 110, the user may tap a “Pickup Info” button (e.g., button 32). Then at step 112, a new page appears, such as a “Pickup Info” page, where info about pickup location and time may be entered. Next, the user may decide whether to enter destination info at step 116. For instance, the user may tap a “Destination” button (e.g., button 34) to open a “Destination” page and then key in a destination address at step 114. If the user needs any service, a “Service” button (e.g., button 36) may be tapped at step 118. Then the user may select one or multiple service options at a “Service” page at step 120. If the user does not want any service inside the vehicle, the “Service” button may be ignored. At the end, the user may tap “Hail Car” button to submit a hailing request at step 122, which also concludes the hailing process at step 124. After “Hail Car” button is tapped, the app may transmit to Service Center information that the user enters. In response, Service Center may send the user a confirmation message which may confirm a hailing request to go to a place, confirm a service that is selected by the user, and provide information about a pickup vehicle and pickup location.

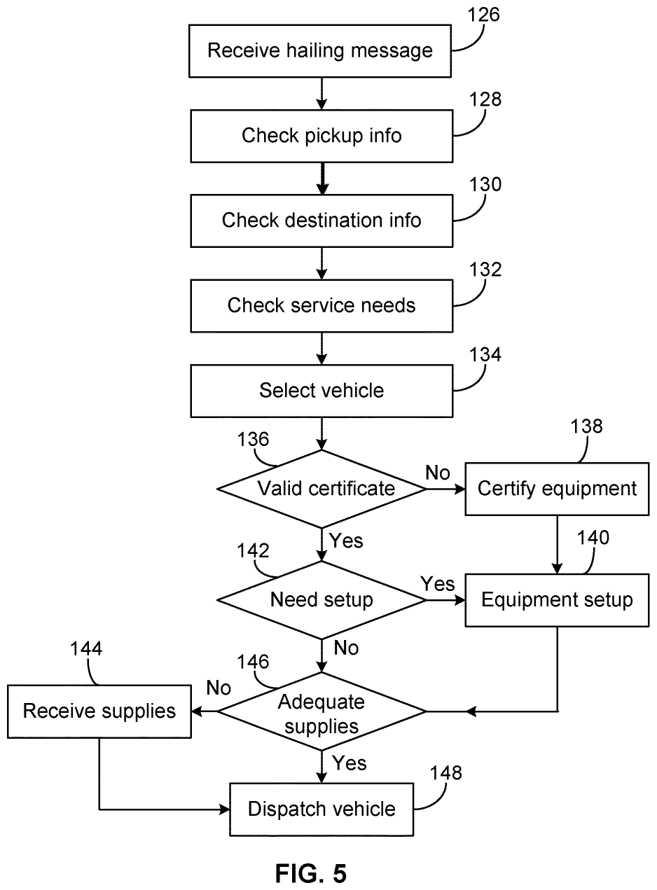

FIG. 5 shows another exemplary flow diagram according to the present invention. The diagram describes a process to handle a vehicle hailing request. Assume that Service Center receives a hailing or reservation message from a user at step 126. The message is sent from a device of the user via an app (e.g., Car App) after the user taps a hail-car button. The hail-car button may function like button 30 as shown in FIGS. 2-3. The message may contain a name of the user, an account number of the user, a request to hail a vehicle, location data of the device, and other information the user submitted or selected. Service Center then starts evaluating the message. At step 128, the center checks whether the message contains any info about pickup time and place. At step 130, the center checks whether the message includes any destination information. At step 132, a service option may be singled out if it is selected by the user. Again, a user may hail a vehicle without giving any information about pickup, destination, or service requests.

After reviewing info received from the user, Service Center may select a vehicle among a group of vehicles at step 134. The selected vehicle has a business platform that provides services requested by the user. The platform may need certain equipment. Next at step 136, Service Center may check whether the equipment has a valid certificate. If a certificate expires already, the equipment may be certified again at step 138 and then go through a setup process at step 140. If the equipment's certificate is still valid, the center may check whether the equipment is set up properly at step 142. If set-up procedures are needed, step 140 is taken to make the equipment work properly. If the equipment doesn't need a certificate, steps 136 and 138 may be skipped. Next at step 146, the center may check whether the vehicle has adequate supplies of materials and consumable components to support a service. For instance, certain food supplies have to be maintained for food services in a vehicle. If the level of supplies is low, step 144 is taken and the vehicle gets re-stocked. Then at step 148, Service Center may send the vehicle to pick up the user.

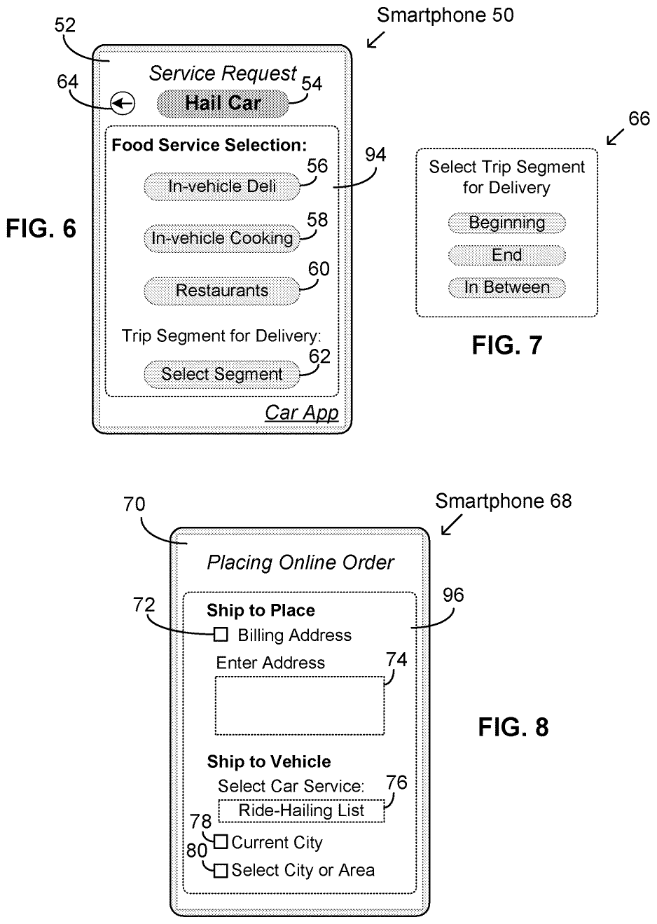

FIG. 6 shows an exemplary diagram of an app interface which depicts options of food services according to the present invention. Provided that the app is still Car App. A smartphone 50 is used as an exemplary device to show the schemes. The interface appears after a user taps a food service button, such as button 42 shown in FIG. 3, to request a food service. On a touch-sensitive screen 52 of the phone, a button 54 is configured for hailing a vehicle. A user may tap the button at any time to hail a vehicle and end a hailing process in the meantime. A button 64 is configured for returning to a previous page. In an area 94 below button 54, interactive buttons 56, 58, and 60 are presented as options of food services. The buttons each have a label to show a service category. For instance, in-vehicle deli, in-vehicle cooking, and restaurants are provided. When button 56 or 58 is tapped, another page may appear showing a list of dishes on a menu. When button 60 is tapped, a list of contracted restaurants may show up. A user may tap a restaurant (e.g., its icon) to open a menu page and then choose dishes. After a user places a takeout order at the restaurant and submits a hailing request by, for example, tapping button 54, the app may transmit the hailing and service request information to Service Center, which then dispatches a vehicle to pick up the user, contacts the restaurant, and sends a transport vehicle to get the takeout order. Then, Service Center directs the transport vehicle to rendezvous with the hailed vehicle that carries the user. The takeout order may be delivered to the user during a trip or after the hailed vehicle arrives at the destination.

When a user taps button 58 to choose in-vehicle cooking, a menu may show up in the interface. Provided that the menu includes spaghetti. The user may tap a “Spaghetti” button (not shown) to make a selection. Then the user may tap “Hail Car” button to submit a hailing request. When Service Center receives the hailing request along with a spaghetti order, the center may select a vehicle which is equipped with spaghetti cooking equipment and has enough spaghetti supplies. For instance, the supplies may include spaghetti sauce and cooked plain spaghetti which may be stored in a refrigerator.

In area 94, a button 62 is also configured. Button 62 provides an option to select a trip segment for delivery. In real life, some users may want to receive a meal package at the beginning of a trip and some may like to have the package after arriving at a place. For instance, the former case may fit users rushing to a place around noon time. A user may have lunch while riding in a vehicle. The latter case may be favored by users going home after work. For instance, a user may place a takeout order at a restaurant via the app and receive the order when a trip ends in front of his or her house. When button 62 is tapped, a window shows up, as depicted schematically in FIG. 7. FIG. 7 shows a window 66 which has a title “Select Trip Segment for Delivery” and three interactive buttons. The buttons may represent three trip sections as delivery options provided for a user. A user may tap a button to select the beginning of a trip, the end of a trip, or a segment in between. It may be designed that when an “In Between” button is tapped, a small window appears to take input from a user. The user may enter details to describe a desired delivery plan, such as delivering “within 5 minutes after the trip starts” or “around intersection of Main Street and First Avenue”. When a user doesn't enter any info in the small window, it may mean any time between the beginning and the end of a trip is okay for delivery.

In above embodiments such as that illustrated in FIGS. 2-3, two options are provided for a user: vehicle hailing only; and vehicle hailing plus one or more services. In some cases, a user may just need a service and does not need a ride to a place. As such, one more option may be provided so that a user may order a service only. Service Center then dispatches a vehicle to the user and provides the requested service via the vehicle. For example, a button with a label such as “Service Only” may be configured in area 92 of FIG. 3. A user may select one or more services via buttons 42-48 and then enter more input and proceed with the procedures. During the process, the user may tap the “Service Only” button. After this button is activated by the user, it may change color or become brighter to indicate that such a request is submitted. The user may enter a pickup place and pickup time. If pickup info is not submitted, the current location and current time may be used as the user's input. After the user taps button 30 to “hail” a vehicle, the app sends a message to Service Center. The message includes services selected and a service only request. When Service Center receives the message, it finds and dispatches a vehicle that has the capacity of the requested services. If, for example, the user just places a takeout order at a restaurant, the center may assign a vehicle to take the order from the restaurant and then go to the pickup location. The user may wait for the vehicle to come and enter the vehicle after it arrives. The vehicle stays put and does not take the user to another place. After the user is recognized or identified (e.g., via a verification code or facial recognition) by a control system of the vehicle, the control system releases the takeout order and transfers it to the user. Similarly, when the user orders other services and activates the “Service Only” button, Service Center may direct a vehicle to go to a pickup place to pick up the user, stay put (or park at a nearby parking spot), and perform services requested, such as a medical checkup and/or massage service. The vehicle leaves the user after the services are provided.

Thus, the app (e.g., Car App) may provide three options to a user via the app interface simultaneously. The first, second, and third option correspond to vehicle hailing only, service only, and vehicle hailing plus service, respectively, while parcel delivery may be done before, during, or after any of the options is implemented. In some embodiments, after a user makes a hailing request, Service Center dispatches a vehicle to a pickup location to find and approach the user. After the hailed vehicle arrives, the user gets in it. Optionally, the user may also stand outside the vehicle and in front of a designated display of the vehicle. The vehicle then starts monitoring the user using sensors (e.g., cameras and microphones) continuously. A control system of the vehicle may try to recognize or identify the user using a recognition technique during a check-in process. After the user is recognized or identified or a payment is received, depending upon what the user has requested, the control system performs one or more tasks accordingly. If the request of the user corresponds to the first option, the control system presents a message to confirm a destination on a display of the vehicle, and starts a journey to drive the user to the destination. An exemplary message may show “Destination: 2001 First Street”. If the request corresponds to the second option, the control system presents a message to confirm services the user ordered on the display, and provides the services (including delivery of a takeout order from a restaurant), while the vehicle stays at the pickup location or drives the user to a nearby parking spot and stays there temporarily. An exemplary message may show “Services ordered: Coffee and Flu shot”. The vehicle drives away after the services are performed and the user leaves the vehicle. If the request corresponds to the third option, the control system presents a message to confirm a destination and services ordered by the user on the display. An exemplary message may show “Destination 2001 First Street with Tea and Massage”. The vehicle starts a journey to take the user to the destination. Before, during, or after the journey, the control system may provide the services (including delivery of a takeout order). As aforementioned, a parcel transported from a shipping company may be released to the user anytime before, during, or after the journey.

In some embodiments, a service is provided in a vehicle after getting consent or permission from a user. For example, when a control system of a vehicle is ready to provide a service (e.g., making a sandwich, cooking a hot meal, or performing a medical checkup) for a user in the vehicle, the control system may present a question to the user. The question may be presented on a touch screen of the vehicle and include a sentence such as “Prepare the sandwich now?”, “Start the checkup now?”, or “Ready for medical checkup?”. Several interactive selection buttons as brief answers may be presented on the screen with labels like “Yes” (or “Start now”) and “No” (or “Not yet”). When a button of a positive reply is tapped, the control system starts to provide the service. When a button of a negative reply is tapped, the control system pauses preparing for the service and waits for further instructions from the user for a certain time. Alternatively, when a button of a negative reply is tapped, the control system may continue preparing for the service without providing it to the user and wait for further instructions from the user for a certain time. Thereafter, the control system presents a question asking for consent again after a given time elapses. Meanwhile, the user may submit a command via the screen or utter a voice command to request the control system to provide the service anytime.

When a hailed vehicle works as a parcel-delivery platform, it gives a user another option to ship an order besides conventional ways. The new option may be called ship-to-vehicle option, meaning that a parcel is shipped to a vehicle and delivered to an occupant of the vehicle, instead of being shipped to a physical address. FIG. 8 is an exemplary diagram describing schemes to select a shipping method. Again a smart phone is used as an exemplary device in the example. Assuming that a user uses a smartphone 68 to place an online order at a seller's website. An interface shown on a touch-sensitive screen 70 may represent a check-out page or screen view during the ordering process. Assume that some items are placed in a virtual shopping cart and it's time to choose a shipping method. After the interface is presented, the app monitors any input the user may submit. The user may enter a name of the recipient, who may be the user or another person. In an area 96, two shipping options are presented. A conventional method, “Ship to Place”, is configured at the top portion of the window. “Ship to Place” may mean a request to ship or deliver a parcel to a physical address. If a user wants the order to be delivered to his or her billing address, the user may check a box 72. Otherwise, the user may key in an address in an input area 74. After box 72 is checked or info is entered in area 74, the user may proceed to the next page and enter other information such as payment info.

Alternatively, a user may choose the “Ship to Vehicle” method. With the “Ship to Vehicle” method, a ride-hailing company sends a parcel to a vehicle which a recipient is riding in, and then delivers the parcel to the recipient. As arranged herein, a ride-hailing company may serve as a transfer station or an intermediate link between a sender and a recipient. A user may tap a small window 76 to see a drop-down list. The list may contain active players in ride-hailing business. When the user taps a company on the list, the company is selected to act as an entity to transport and deliver the order, which also means the user chooses the ship-to-vehicle method. Two check boxes (not shown) may also be arranged for a user to select the ship-to-place or ship-to-vehicle option in the interface. A user may check one box to make a selection. Assuming that the user is also the recipient in the example and the user has an account at a selected ride-hailing company. If the seller doesn't have the user's account number at the selected ride-hailing company, a window may pop up in the interface with a message asking the user to enter the account number. The reason is that a ride-hailing company may only deliver a parcel to an occupant of a vehicle, when the company can recognize the occupant based information retrieved from the occupant's account at the company. In other words, the ship-to-vehicle method only works for recipients who are registered members of a ride-hailing company or who can be recognized by the company in advance.

When the seller lacks info of a recipient's account number of a ride-hailing company, an option may be presented in the interface for a user to enter it. When a user sends a parcel to another person, and doesn't know the person's account number at a ride-hailing company, the user may submit the person's physical address. After receiving a parcel, a ride-hailing company may verify whether a recipient is a registered member based on the recipient's name and address. If the recipient is not a registered member, the ride-hailing company may deliver the parcel to the recipient's address or let a shipping company to deliver it.

Return to FIG. 8. When the ship-to-vehicle option is selected, a parcel may be sent to a ride-hailing company or the company's vehicle first, and delivered to a recipient at the next step. After choosing a ride-hailing company, a user may check a box 78 or 80. When box 78 is checked, it means a user wants the parcel to be shipped to a city or area where the user is currently in. If the user wants to deliver the parcel to another city or area, box 80 should be checked and a city or area name may be entered. After a user chooses the “Ship to Vehicle” method, the seller may send the info to a shipping company. Then the shipping company may contact a selected ride-hailing company after the parcel arrives at a local warehouse. At the final leg, either the shipping company or the ride-hailing company may transfer the parcel to a vehicle which a recipient is riding in. More details on shipping are illustrated in the following section.

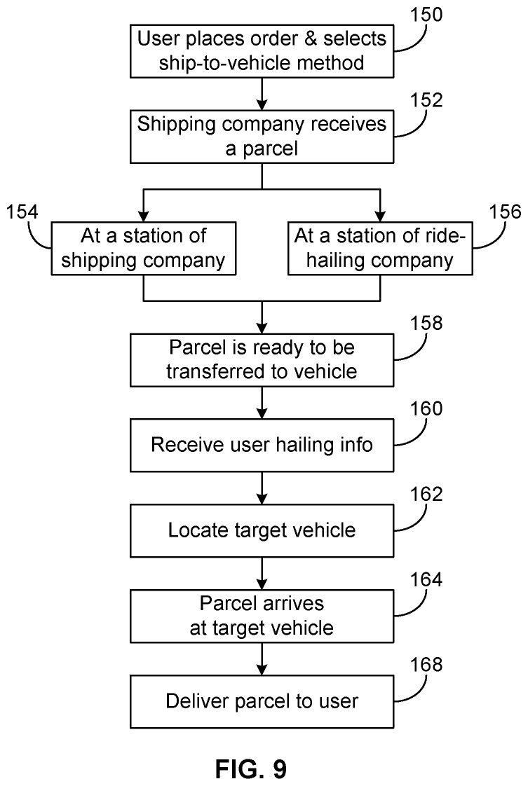

FIG. 9 shows a schematic flow diagram describing methods to ship a parcel according to the present invention. Assuming that a user places a purchase order at a seller's website at step 150. The user is the recipient and wants to receive the order via a hailed vehicle, i.e., the user wants to use the ship-to-vehicle method. Next the user selects a ride-hailing company and submits the order. Afterwards, the seller prepares a parcel for the order, and passes the parcel to a shipping company at step 152. In a conventional way, the shipping company may ship the parcel to a physical address. Since the user chooses the ship-to-vehicle method, the shipping company plans to send the parcel to the selected ride-hailing company or to a vehicle of the ride-hailing company, depending upon a contract between the two entities. At step 154, which reflects the latter case, the parcel is sent to a local station of the shipping company. The parcel stays at the station until the user hails a vehicle. At step 156, which represents the former case, the parcel is sent to a local station of the selected ride-hailing company. Similarly, the parcel remains there until the user hails a vehicle.

At step 158, the parcel is ready for the next stage at a station of either the shipping or the ride-hailing company, i.e., ready to go to a vehicle assigned to the user. Assuming that the ride-hailing company is managed by Service Center. Next, Service Center sends the user a message to inform him or her that a parcel is ready for delivery. For example, Service Center may send a notification via Car App, short message, or email. At step 160, the center sends another message. The message is sent to either station which confirms that the user, who is the recipient as assumed here, has submitted a vehicle hailing request. For instance, Service Center may receive a message from a device of the user that the user entered a hailing request. Then at step 162, Service Center may receive info that a target vehicle is assigned to the user. The info may include description of the target vehicle, its current location, and a scheduled route. A target vehicle may detect its location by an onboard positioning system such as GPS and transmit location data to Service Center continuously. Service Center may send related data to the shipping company if the shipping company has the parcel and is scheduled to transfer the parcel to a target vehicle. Next Service Center or the shipping company dispatches a transport vehicle or UAV to catch the target vehicle. It may be designed that Service Center may calculate to obtain a location or a segment of a road as a proposed transfer place and then arrange a target vehicle and a transport vehicle or UAV to meet there. After some time, the transport vehicle or UAV approaches the target vehicle and transfers the parcel to the vehicle at step 164. In some cases, the parcel may be transferred to the target vehicle before the user gets in the vehicle. In some other cases, the parcel may be transferred to the target vehicle after the user gets in the vehicle. Next at step 168, the parcel is delivered to the user.

After a parcel arrives at a vehicle, the vehicle's control system may present a message to a user in there. The message may be presented on a touch screen with an announcement and a question, such as “Dear Mr. John Doe: A parcel arrives. Receive it now?” or “Dear Mr. John Doe: A parcel is ready. Receive it now?”. Several selection buttons as brief answers may also be presented on the screen with labels like “Receive now”, “Receive at destination”, and “Refuse parcel”. When button “Receive now” is tapped, the parcel may be transfer to the user via a transfer device installed at the vehicle. When button “Receive at destination” is tapped, the user may pick up the parcel after a trip is completed. At the destination, the user may get the parcel from a compartment inside the vehicle. The user may also get off the vehicle and open a cover of the vehicle to get the parcel. When a parcel has a large size, a user may have to get it from outside of a vehicle at the end of a journey. If button “Refuse parcel” is tapped, it may mean the user refuses to receive the parcel. Then the parcel may be returned to a sender.

Further, an option may be provided for a parcel to be shipped to a physical address. For example, an additional button with a label such as “Send it to home address” may be configured beside other selection buttons illustrated above on a screen inside the vehicle. For example, when the vehicle's control system presents a question such as “Receive your parcel now?” and answer buttons like “Receive now”, “Receive at destination”, and “Refuse parcel”, it may display the additional “Send it to home address” button. After the vehicle's control system detects that the additional button is activated, it considers that the user wants the parcel to be shipped to the home address. Then, the control system sends a message to Service Center to report the request from the user. Service Center may instruct the vehicle to transport the parcel to a warehouse, and then the center ships it to the home address of the user at a later time. Optionally, after the user taps the additional button, the control system may provide another option. For example, the control system may present a space on the screen where the user may enter another address for shipping the parcel. After Service Center receives the new address, the center may use it to deliver the parcel.

It may be arranged that a user may select a trip segment for delivery when the user hails a vehicle, i.e., before a trip begins. For instance, when a button such as button 38 as shown in FIGS. 2-3 is tapped, a selection window similar to window 66 as shown in FIG. 7 may be displayed along with textual info about the parcel in the app interface. Hence, similar to aforementioned methods, a user may request to receive a parcel at a specific part of a trip, like at the beginning, the end, a certain time slot, or a segment of a journey. Such a request may be made whenever a user wants to do it before or after getting in a vehicle. A selection window like window 66 shown in FIG. 7 may also be configured in a check-out interface at an e-commerce website. For instance, options for trip segment selection may be arranged in area 96 of FIG. 8. Then a user may choose a trip segment for delivery when placing a purchase order.

Furthermore, as there is a need to receive a parcel or order at a place, not in a vehicle, another option may be arranged in a selection window, such as window 66 shown in FIG. 7. For instance, two more buttons may be configured in the window, with labels like “Receive at Current Location” and “Receive at Another Location”. The former button may mean a user requests to receive a parcel at the present location. Once the button is tapped, address of a user's location may be presented and the user may add more detail to the address in an input area for a smooth delivery. Then the user may tap a button with a label like “Submit” to send the request to Service Center. The option may be desirable for users at home when, for example, there is a need to order a meal from a local restaurant. If the latter button is tapped, it may mean a user requests the parcel to go to another place. A user may enter a delivery address in an input space in the window and then tap the “Submit” button. Therefore, a user may decide to receive a parcel in a vehicle or at a place conveniently. The selection window may be configured in a purchasing or ordering interface of a website or app, and a vehicle-hailing interface of a website or app.

When a package is too big or too heavy for a hailed vehicle to carry, such as larger than a given dimension, Service Center may notify a user that a parcel will be available at the end of a trip. In addition, an option to skip parcel delivery for a trip may be presented in an interface. For instance, a check box with a label “Don't delivery it this time” may be configured in a selection window, such as window 66 shown in FIG. 7. If a user wants to get a parcel later, the user may check the box to put the parcel on hold temporarily. Then Service Center may cancel a parcel delivery plan and wait for the next time. When a parcel is to be delivered at the end of a trip, either by a user's request or a decision made at Service Center, it becomes optional to transfer the parcel to a target vehicle. When arranging a delivery at the end of a trip, Service Center may have two options if a parcel is suitable to be transferred to a target vehicle. The center may send the parcel to the target vehicle when the vehicle is on a road or send the parcel to the destination. In the latter case, Service Center may direct a transport vehicle or UAV to a destination place and instruct it to meet a target vehicle or a user there. At a destination place, a parcel may be transferred to a target vehicle first. The target vehicle then delivers the parcel to a user. The transport vehicle or UAV may also deliver a parcel to a user directly, without the involvement of a target vehicle. Service Center may choose one between the two options based on predetermined rules.

In addition, when the dimensions or weight of a parcel is larger than a given value, it may be arranged that Service Center may ask for permission of a recipient before delivering it. The permission may prevent unnecessary waste of time and effort of a ride-hailing company. For instance, when a parcel is oversized, Service Center would not deliver it without getting permission or authorization from a recipient. To emphasize that a recipient's permission is required, another label may be assigned to button 38 as shown in FIGS. 2-3 when there is an oversized parcel. The label may read, for example, “Authorization needed for delivery.” After the button is tapped, an authorization page may show up. A user may check a box or tap a button to allow Service Center to deliver it or check another box to postpone the delivery. For instance, when a user orders a big screen television for his or her apartment, the user may authorize delivery of the television when hailing a vehicle to return home.

As illustrated above, when a parcel is delivered at a destination at the end of a trip, a user may get the parcel from a transportation vehicle or UAV which also arrives there (i.e., the destination area). The transportation vehicle or UAV may get info from Service Center and thus may know where a target vehicle may drop off a passenger and a proximate arrival-time slot. After a user gets off a target vehicle at the destination place, the user may follow instructions sent from Service Center and walk to the transport vehicle or UAV which may be parked nearby. Next a parcel may be released after a code verification process or a facial recognition process is completed.

As a trip is known before a journey starts, Service Center may determine whether to use the destination of the trip as a preferred place for delivering a parcel based on factors such as the cost and difficulty level. Compared to delivery at destination, in some cases, it may need a more sophisticated vehicle to transfer a parcel to a hailed vehicle during a trip and thus costs more. In some implementations, it may be more difficult and risky to transfer a parcel to a hailed vehicle during a trip. If transferring a parcel at destination is safer or costs less, Service Center may choose delivery at destination as a preferred option, instead of delivery during a trip. Further, the cost may also include the time needed for transporting a parcel. Based the pickup time, the route of a trip, the destination location, and road and traffic conditions, the center may calculate the time difference between transporting a parcel from a warehouse to a hailed vehicle during a trip and transporting the parcel to the vehicle or a user at destination through certain algorithm. In some embodiments, when an app (or Service Center) has info about the route of a trip and a user taps button 38 as shown in FIGS. 2-3 before or during a ride, the app may present a message in a window similar to window 66 shown in FIG. 7. The message may contain a notification such as “Parcel to be delivered at destination”. The app may also present an interactive button with a message such as “Deliver parcel during trip”. As such, two options are provided by the app. The user may consent to the arrangement, or tap the “Deliver parcel during trip” button to request the parcel to be delivered in the middle of the trip. The request to change delivery location, however, may need approval by Service Center in certain cases. In some embodiments, after a user enters a vehicle and gets recognized by a control system of the vehicle, the control system may present a message on a display of the vehicle to notify or remind the user of parcel delivery at destination. Such messages may include, for example, “A parcel is ready at destination”, “A parcel will be delivered at destination”, or “You have a parcel. Will be delivered at destination.” Optionally, the control system may also present an interactive button with a message such as “Deliver parcel during trip”. Thus, two options are provided to the user by the control system. The user may agree to the arrangement and do not response, or tap the “Deliver parcel during trip” button to request the parcel to be delivered during the journey. With the consent of the user, after the vehicle arrives at the destination, the parcel may be released and delivered to the user in various manners as illustrated above.

In some embodiments, transfer boxes may be installed along select routes and places. For example, the transfer boxes may be placed by the roadside or at a parking lot at select spots. When Service Center receives info that a user makes a hailing request for a trip and a parcel at a warehouse is ready for delivery to the user, the center instructs a vehicle to pick up the user and orders a transport vehicle to take the parcel and put the parcel in a transfer box. The transfer box may be close to the pickup location, destination area, or a section of the route of the trip. After the user gets in the vehicle, a control system of the vehicle performs check-in procedures including recognizing the user, and navigates the vehicle to the transfer box based on instructions obtained from Service Center. When the vehicle approaches and stops beside the transfer box, the control system communicates with the transfer box and requests the transfer box to release the parcel. For example, after the transfer box verifies a code submitted by the control system, the transfer box may open a door and use a mechanical arm to place the parcel inside the vehicle. Alternatively, the control system may also ask the user to take the parcel from the transfer box. The user may stay in the vehicle or get off the vehicle to get the parcel. Thereafter, the vehicle continues the journey to the destination. If the transfer box is in the destination area, the vehicle may drop off the user and the user may walk to the transfer box, following instructions transmitted from Service Center. The transfer box or a control system of the transfer box may verify a code the user enters or a QR code that the user presents, and release the parcel after the code or QR code is verified in the verification process.

As aforementioned, both a shipping company and a ride-hailing company may send a parcel to a target vehicle. But a ride-hailing company may have advantages to do it, because communication between a transport vehicle and a target vehicle may be smoother when they belong to the same company.

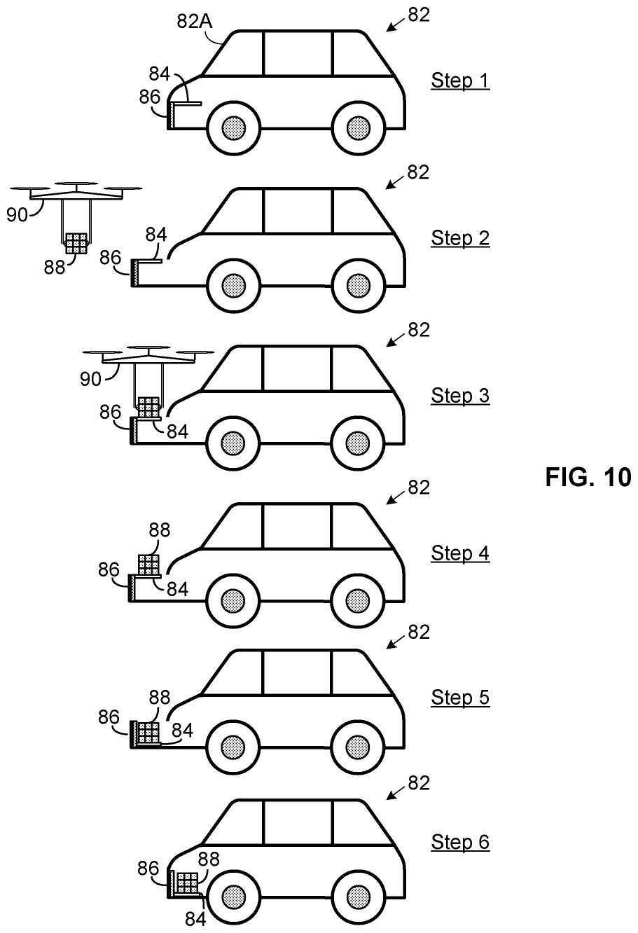

FIG. 10 shows exemplary diagrams to illustrate a parcel transfer process according to the present invention. Provided that a vehicle 82 is a target vehicle which a user rides in. The vehicle has a windshield 82A and a retractable landing pad 84 which is connected to a cargo door 86. Assuming that at Step 1, a transport UAV 90 finds vehicle 82. At Step 2, UAV 90 with a parcel 88 approaches the vehicle. After communicating with UAV 90, a control system of vehicle 82 may release pad 84 and push it out. The pad now is fully exposed and ready to receive a parcel, as shown in the figure. Next at Step 3, UAV 90 places the parcel on pad 84. The parcel is secured on pad 84 at Step 4, for example, by a locking mechanism. Then at Step 5, pad 84 is lowered. Next, at Step 6, pad 84 is retracted, cargo door 86 is closed, and parcel 88 is transferred inside the vehicle. It is noted that the UAV may be dispatched by a shipping company or a ride-hailing company.

As the flight of a UAV may be affected by air turbulence, especially in a rainy or windy day, it may be arranged that a target vehicle may slow down below certain speed or stop at a place in order to receive a parcel safely and in a more secured and controlled way. For instance, Service Center may calculate to get an optimized transfer place where a parcel may be passed from a UAV to a vehicle. And then the center may inform a target vehicle and a transport UAV about the transfer place. The target vehicle may slow down or stop at the transfer place and meet the transport UAV there. It is seen that a target vehicle may slow down or stop for other types of transport vehicles besides UAVs when a parcel needs to be transferred. In some embodiments, vehicle 82 may be an autonomous vehicle. In some other embodiments, vehicle 82 may be a driver-operated vehicle. In the latter scenario, a driver may open cargo door 86 and control the movement of pad 84. As such, the methods described above apply to both autonomous vehicles and conventional vehicles with drivers. Further, methods described below apply to both autonomous vehicles and conventional vehicles as well.

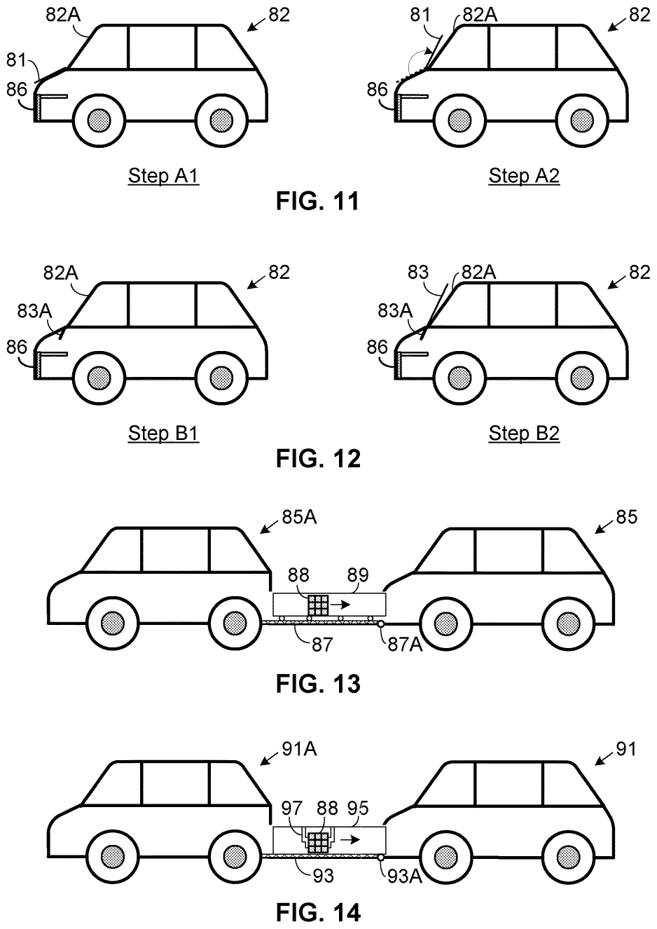

FIGS. 11 and 12 show exemplary diagrams that illustrate methods to use a barrier to protect windshield 82A of vehicle 82 according to the present invention. As sown in FIG. 10, there exist risks of collisions between UAV 90 and windshield 82A of vehicle 82. The risks may increase in a windy day or when a control failure of UAV 90 happens. In order to protect windshield 82A, a barrier may be mounted that prevents a direct hit on the windshield. However, a barrier in front windshield 82A may block the view and is unsightly.

Referring to FIG. 11, a barrier 81 is mounted below windshield 82A. Barrier 81 may have a structure similar to a fence or net made of metal and plastic material. Barrier 81 may be designed to withstand a hit from a UAV or a package carried by the UAV. At Step A1, barrier 81 is at a rest position, e.g., on top of the hood of vehicle 82. Barrier 81 does not block the view from behind windshield 82A. At Step A2, after communicating with a UAV that is approaching vehicle 82, the control system of vehicle 82 rotates barrier 81 from the rest position to a defense position in front of windshield 82A to protect the windshield. Optionally, barrier 81 may be placed in front of windshield 82A when the UAV is within a preset distance, for example, when the distance is smaller than a first value (e.g., 20 meters) and larger than a second value (e.g., 2 meters) from vehicle 82. The preset distance is arranged to set up barrier 81 in time, while avoiding the barrier hitting the UAV or a parcel carried by the UAV. Barrier 81 may have holes designed so that it blocks the view from behind windshield 82A to a minimum. As barrier 81 is placed in front windshield 82A only when a UAV arrives, the view remains clear most of the time. Besides rotation, barrier 81 may also be moved by other means. For example, it may be pushed or pulled to the working position.

FIG. 12 shows exemplarily another method to use a barrier to protect windshield 82A. In some embodiments, a barrier 83 may be retractable and placed inside a sheath 83A. Sheath 83A, as a holder of barrier 83, may be disposed under the hood or beneath the outer shell of vehicle 82. As such, sheath 83A may be invisible to people around vehicle 82 and does not affect the appearance of the vehicle. In some other cases, sheath 83A may be mounted on the hood or the outer shell of vehicle 82.

At Step B1, barrier 83 is in the retracted state inside sheath 83A. At Step B2, after communicating with an approaching UAV, the control system of vehicle 82 places barrier 83 in front of windshield 82A. Being retractable, barrier 83 may be pulled or pushed out of sheath 83A. Barrier 83 may be positioned in front of windshield 82A when the UAV is within a preset distance, for example, when the distance is smaller than a first value (e.g., 20 meters) and larger than a second value (e.g., 1 meter) from vehicle 82. Similar to barrier 81, barrier 83 may have holes designed so that it blocks the view from behind windshield 82A to a minimum. As barrier 83 is put in front windshield 82A only when a UAV arrives, the view remains clear most of the time.

FIGS. 13 and 14 illustrate exemplary diagrams about transferring a parcel from a vehicle to another vehicle according to the present invention. As shown in FIGS. 13-14, vehicles 85A and 91A are transport vehicles. The transport vehicles carry parcels and transfer the parcels to vehicles such as vehicles 85 and 91. Vehicles 85 and 91 may be hailed vehicles or target vehicles that are booked by users, take the users to destinations, pass the parcels to users, and are vehicles to which target vehicles transfer parcels. Optionally, vehicle 85 and 91 may also be transport vehicles that take parcels and then transport them to target vehicles.

Referring to FIG. 13, vehicle 85A has a connector 87 and vehicle 85 has a joint 87A at the front end. After vehicles 85A and 85 are aligned along a direction and vehicle 85A is positioned at a certain distance (e.g., 5-10 meters) in front of vehicle 85, connector 87 is extended out towards vehicle 85 until a certain length of connector 87 is outside. The distance between the two vehicles is decreased until connector 87 getting connected with joint 87A. Then, connector 87 and joint 87A are connected articulately, i.e., vehicles 85A and 85 are connected articulately. The two vehicles may drive and make turns together. In some cases, vehicles 85 and 85A may be connected through joint 87A, when vehicle 85 is stopped and vehicle 85A moves backwards toward vehicle 85. In some other cases, vehicles 85 and 85A may be connected through joint 87A, when both vehicles 85 and 85A drive at certain speeds on a road. The above connection process may be implemented autonomously, e.g., through control systems of vehicles 85A and 85. For example, the control system of vehicle 85A may issue commands to open a back door (not shown) of vehicle 85A, extend connector 87 out of the back door, and then cause connector 87 to engage joint 87A. Optionally, the above connection process may be performed by a driver, e.g., a driver at vehicle 85A.

Thereafter, a duct 89 may be placed on an end of connector 87 facing vehicle 85A and pushed out or pulled out. Duct 89 may be moved to a position between vehicles 85A and 85 and get fixed on connector 89, providing a passage or channel to vehicle 85. Optionally, duct 89 may be an enclosed passage with two opposite openings facing vehicles 85A and 85, respectively. In some cases, before connector 87 is connected with joint 87A, duct 89 is already mounted on connector 87. Optionally, connector 87 may always carry duct 89 or duct 89 may be fastened on top of connector 87 all the time when vehicle 85A is in operation. Optionally, one or more cameras (not shown) may be configured in duct 89 to monitor parcel 88, such as detecting the position and speed of parcel 88. Parcel 88 may be transferred from vehicle 85A to vehicle 85 via duct 89. For example, parcel 88 may be pushed or pulled to complete a journey from vehicle 85A to vehicle 85.

Referring to FIG. 14, vehicle 91A has a connector 93 and vehicle 91 has a joint 93A at the front end. After vehicles 91A and 91 are aligned along a direction and vehicle 91A is positioned at a certain distance in front of vehicle 91, a back door (not shown) of vehicle 91A is opened, connector 93 is extended out through the back door towards vehicle 91 until a certain length of connector 93 is exposed outside. Meanwhile, a cargo door (not shown) at the front end of vehicle 91 may be opened, getting ready for parcel transfer. The distance between the two vehicles is decreased until connector 93 is connected with joint 93A. Connector 93 and joint 93A are connected articulately. As such, vehicles 91A and 91 are connected articulately. The two vehicles may drive and make turns together. In some cases, vehicles 91A and 91 may be connected through joint 93A, when vehicle 91 is stopped at a place and vehicle 91A moves backwards toward vehicle 91. In some other cases, vehicles 91A and 91 may be connected through joint 93A, when both vehicles 91A and 91 drive at certain speeds on a road. The above connection process may be implemented autonomously, e.g., through control systems of vehicles 91A and 91. For example, the control system of vehicle 91A may generate commands to open the back door of vehicle 91A and the cargo door of vehicle 91, push out connector 93 out of the back door, and make connector 93 engage joint 87A. Optionally, the above connecting process may be performed manually by a driver, e.g., a driver or technician at vehicle 91A.

Thereafter, a duct 95 may be placed on an end of connector 93 at vehicle 91A and pushed out or pulled out toward vehicle 91. A gripper 97 may be installed inside duct 95 that may grab or hold parcel 88. Gripper 97 is a holder and may have a robotic hand. Optionally, a rail (not shown) may be mounted on the ceiling of duct 95. Gripper 97 may be attached to the rail and move along the rail. Duct 95 may be moved to a position between vehicles 91A and 91 and then get fixed on connector 93. Duct 95 provides a passage or channel between vehicle 91A and vehicle 91. Optionally, duct 93 may be an enclosed passage with two opposite openings facing vehicles 91A and 91, respectively. In some embodiments, before connector 93 is connected with joint 93A, duct 95 may be placed on connector 93. Optionally, connector 93 may always carry duct 95 or duct 95 may be fastened on top of connector 93 all the time. In such cases, duct 95 and connector 93 may be moved in and out of vehicle 91A together. Next, parcel 88 may be transferred from vehicle 91A to vehicle 91 along the rail by gripper 97. In some cases, one or more cameras (not shown) may be installed in duct 95 to monitor parcel 88, such as detecting the position and speed of parcel 88. After parcel 88 is taken to the opening of duct 95 proximate to vehicle 91, gripper 97 may release parcel 88 and push parcel 88 inside vehicle 91. The parcel transfer process between the vehicles may be carried out autonomously or manually.

When a vehicle approaches another vehicle to get connected articulately, e.g., via joint 87A or 93A and connector 87 or 93, and the two vehicles are within a short distance (e.g., shorter than 10 meters), a selected one of the control systems of the two vehicles may take control of both vehicles. As such, the selected control system may navigate both vehicles concurrently, while performing the connector-joint connection process. The selected control system may control both vehicles until after the vehicles are disconnected and separated by a certain distance (e.g., 5-10 meters). It may make the connecting process smooth and efficient.

Before a parcel is transferred from a UAV or transport vehicle to a hailed vehicle, e.g., from UAV 90 to vehicle 82 as shown in FIG. 10, a confirmation process may be configured to make sure a corresponding user does want to receive the parcel. It may avoid bothering the user and waste of resources and energy. The confirmation process may be arranged in a time period after the UAV or transport vehicle gets close (e.g., within a certain short distance from a hailed vehicle) and before the parcel is moved to the hailed vehicle.

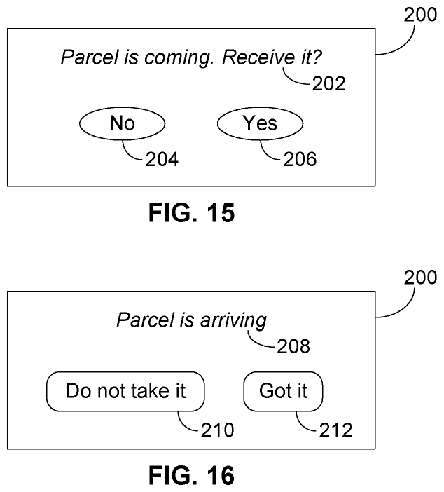

FIGS. 15 and 16 are exemplary diagrams illustrating methods to get user consent for delivering a parcel and provide options for a user to receive or refuse the parcel according to the present invention. Assuming a user is in a target vehicle and a transport vehicle is approaching the target vehicle to transfer a parcel. The parcel is scheduled for delivery to the user. The transport vehicle may be a UAV (e.g., UAV 90 in FIG. 10) or a vehicle (e.g., vehicle 85A or 91A in FIGS. 13 and 14). When the transport vehicle approaches and is within a certain distance (e.g., 20-50 meters) from the target vehicle, the target vehicle may get consent from the user before delivering the parcel to the user. Assuming the user has consented to receive the parcel at the target vehicle before the transport vehicle arrives. But for better user experience, the user is asked again for consent.

Referring to FIG. 15, a display 200 presents a message 202 and buttons 204 and 206. Display 200 may be a display mounted inside the target vehicle. Optionally, display 200 may be a display of a smartphone when the user opens an app such as the above-mentioned Car App at the smartphone. Messages to the user, e.g., message 202, may be presented via a display of the vehicle and/or a display of the smartphone of the user. When the transport vehicle is within a certain distance (e.g., 20-50 meters) from the target vehicle, message 202 may be presented at the display. Message 202 informs the user of the coming parcel and asks whether the user wants to receive the parcel. Exemplary message 202 may include “Parcel is coming. Receive it?”, “Your parcel arrives. Do you receive it now?”, “Your parcel is coming. Would you accept it now?”. Buttons 204 and 206 on display 200 are interactive graphic objects with labels like “No” and “Yes”, representing a negative answer and a positive answer, respectively. Activation of button 204 indicates the user refuses the parcel presently. Then the parcel may be delivered to the user at a later time. Activation of button 206 indicates the user wants to receive the parcel presently.

If the user taps button 204 to refuse the parcel, the target vehicle obtains the information and then transmits a message to the transport vehicle, reporting the refusal event. In response, the transport vehicle may terminate the transfer process and leave the target vehicle.

If the user taps button 206, the transport vehicle continues approaching the target vehicle. Optionally, the transport vehicle may emit light such as green or blue flashes visible to the user at the target vehicle. The flashes serve as alert signals informing the user of the coming of the parcel, helping the user get prepared to receive the parcel.

After the user taps button 206 to accept the parcel and before the parcel is transferred from the transport vehicle to the target vehicle, an option may be provided to the user that allows the user to change the previous decision and refuse the parcel, which is shown schematically in FIG. 16. For example, display 200 may show a message 208 along with interactive buttons 210 and 212. Message 208 may include content like “Parcel is arriving”, “Parcel transfer in progress”, or “Getting parcel soon”, reminding the user of the arriving parcel. Button 210 may have a label such as “Do not take it” or “Sorry, refuse the parcel”, providing convenience for the user to refuse the parcel. Optionally, button 212, with a label like “Got it”, may be arranged beside button 210 to let the user confirm again the willingness to receive the parcel. In above cases described in FIGS. 15 and 16, if no button is activated, it may be considered the user wants to get the parcel currently. Optionally, the user may utter a word or sentence to accept or refuse the parcel, when a speech recognition mechanism is arranged in the process.

### CONCLUSION, RAMIFICATIONS, AND SCOPE

Thus it can be seen that systems and methods are introduced to provide services for a user in a vehicle.

The systems and methods have the following main features and advantages:
(1) A user may order a service when hailing a vehicle;
(2) A user may order cooking, massage, and medical services when hailing a vehicle;
(3) A user may receive a parcel when riding in a hailed vehicle;
(4) A user may select a ride-hailing company to deliver a parcel when placing a purchase order;
(5) An alert message or notification may be presented in a vehicle-hailing interface when a parcel is ready for delivery to a user;
(6) A user may select a section of a trip to receive a parcel;
(7) A parcel may be transferred to a vehicle from a UAV or another vehicle; and
(8) A user may request another occupant in a vehicle is the same gender.

Although the description above contains many specificities, these should not be construed as limiting the scope of the invention but as merely providing illustrations of some of the presently preferred embodiments. Numerous modifications will be obvious to those skilled in the art.

### Ramifications

Embodiments illustrated herein apply to both autonomous vehicles and conventional vehicles with a driver, and can be combined in various ways.

A company may also be arranged to have the functionality of both ride-hailing and conventional shipping services. Consequently, a company may provide ride-hailing services for users, deliver parcels to vehicle occupants, and deliver parcels to physical addresses. For instance, when the company receives a parcel, it may check whether a sender selects the ship-to-vehicle or ship-to-place method. If the former is selected, the company may wait for a recipient to hail a vehicle and deliver the parcel when the recipient is in a hailed vehicle, assuming that the recipient has an account with the company. If the latter is selected or the recipient doesn't have an account, the parcel may be delivered to a physical address of the recipient.

When a company combines ride-hailing and conventional shipping capabilities together, it may deliver a parcel using either the ship-to-vehicle or ship-to-place method. It may choose one method based on a user's request or its own rules. In addition, a user may not be required to select one between the ship-to-vehicle and ship-to-place options. When submitting shipping info, a user may provide the name of a recipient, who may be the user or another person, the recipient's account number at the company, and a physical address of the recipient. A user may obtain an account number from a company, for instance, through a registration process at the company's website or an app of the company. The account number may be used for submitting a vehicle-hailing request. A user may enter a recipient's info through an interface of an e-commerce website or the app when placing an order. The interface may look like that shown in FIG. 8 with some modifications. On the other hand, a user may also just submit a recipient's name and account number in some embodiments, or a recipient's name and address in some other embodiments.

When a company, with combined ride-hailing and conventional shipping capabilities, receives a parcel, it may check the recipient's info first. If the company has the recipient's name, account number, and address, it may send the parcel to a vehicle and then deliver the parcel to the recipient when the recipient rides in the vehicle. As the company may send an alert message or notification to the recipient before the delivery, the recipient may elect to receive the parcel in a vehicle or at a place. If the company has the recipient's name and account number only, it may have similar arrangement, i.e., delivering the parcel to the recipient when the recipient rides in a hailed vehicle. As illustrated above, the recipient may elect to receive the parcel in a vehicle or at a place. When the company only has the recipient's name and address, it may deliver the parcel to the address as a conventional shipping company usually does.

A vehicle may have multiple business platforms. For instance, a mini kitchen and a massage seat may be installed at a vehicle. A user may select both cooking and massage services in advance. Later on, the user may have a meal followed by a massage while riding in a vehicle.

A user may also hail a vehicle without installing an app like Car App at a device. As well-known, many electronic devices may run an app via a remote device or remote server. For instance, Service Center may prepare two apps, one for installation at a gadget and the other for remote access. The latter version may be designed with less data and processing demand and less complexity. It may enable a device to access a remote server and obtain needed data of an app quickly. Examples of the latter version may include the mini programs, Instant Apps, or micro apps which are currently in practice.

Provided that a user uses an electronic device to access a hailing program at Service Center and runs the program to hail a vehicle. An app interface similar to that shown in FIG. 2 may be created on a screen of the device. The interface may have all the options provided by the interface as shown in FIG. 2. The user may enter pickup and destination info via the interface. The user may also hail a vehicle without entering any info. For instance, after the app interface shows up, a user may use one tap to hail a vehicle by tapping a hailing button in the interface, like button 30 shown in FIG. 2. Assuming that the user doesn't have a valid account at Service Center or the center doesn't know the user's account info. Provided that the location option is enabled at the device. After the hailing button is tapped, a message is transmitted from the device to Service Center. The message only contains location info and a hailing request, as the user hasn't submitted any info yet. After Service Center gets the request, it may dispatch a vehicle to a place where the user is in and send a confirmation message to the user. The confirmation message may show up in the app interface, which may contain where and when a vehicle will arrive and a confirmation number or code (e.g., a numerical number, a bar code, or a QR code). The confirmation number, bar code, or QR code may be used for verification or identification when the user checks in a hailed vehicle. The user may provide destination and payment info to a control system of the hailed vehicle during or after a check-in process. Additionally, a user, who doesn't have an account number at Service Center, may also select one or more services via the app interface when hailing a vehicle.

Vehicles with one or more business platforms may be categorized and labeled. When a user requests a service, Service Center may filter available vehicles by a label and certain conditions to get a short list. Then the center may evaluate vehicles on the short list with more factors and select one for the user.

Assuming that a shipping company and a ride-hailing company are operated separately. As illustrated by FIG. 9, there are two ways to transfer a parcel to a vehicle, depending upon a contract between the two companies. If the ride-hailing company does it, the shipping company may ship the parcel to the ride-hailing company which then may send it to a local station waiting for the next step. Once the ride-hailing company receives a message that the recipient hails a vehicle and a target vehicle is chosen, it may transfer the parcel to the target vehicle.

On the other hand, if the shipping company is assigned to transfer the parcel to a target vehicle, the company may send related info to the ride-hailing company. The info may include a recipient's name, address, account number when available, and certain data about the parcel. In response, the ride-hailing company may send the shipping company a message which may specify an area where the parcel may be delivered. Then the shipping company may send the parcel to a station in or close to the area. Once the recipient hails a vehicle and a target vehicle is determined, the ride-hailing company may send another message to the shipping company. The message may contain location info of the target vehicle and a scheduled route. The ride-hailing company may send location info about the target vehicle continuously until a transport vehicle finds the target vehicle.

In some embodiments as illustrated above, tapping a button is used to enter an input or interact with a system. Since a client system or a control system of a vehicle may have a voice recognition mechanism, a user may use a voice command to replace or complement a tapping act in above embodiments. For instance, a user may speak to a smartphone, instead of tapping buttons on a screen, to complete a vehicle hailing process or complete a hailing process and a service request. It is noted that a user may speak a few words or one sentence to complete a hailing process, which may resemble the one-tap hailing act. For instance, a user may open a hailing app by tapping a launch button or say something like “Start car hailing” to a smartphone. Next a hailing interface, like that of FIG. 2, may appear. The user may issue a voice request to hail a car using a few words. The user may say something like “Hail a car”, “Need a car”, or “Get me a car” without providing other info. The app may receive the voice input, interpret it via voice recognition techniques, and convert the voice input into the user's command. Then the hailing request, which is the same as that when a hailing button is tapped, is send to Service Center and the hailing process is completed in the meantime. Hence, a one-tap-to-hail-a-car process may be replaced by speaking a few words to hail a car.

If a user wants to enter pickup time in a hailing process, the user may say “Pickup time 10 am” and then a screen may show “Pickup time 10 am”, meaning the voice command is received. Similarly, more info may be entered via voice input, like destination information and a service request. For instance, after a user says “Service”, the act may equal tapping a “Service” button and a service page may appear in the app interface. The user may proceed with more voice commands. In a similar way, a user may speak to a control system of a vehicle, instead of tapping buttons or keying in words on a touch-sensitive screen during or after a check-in process. For instance, a user may say “Give me the parcel now” after a message like “Parcel arrives” or “A parcel is ready” shows up on a screen when the user rides in a vehicle. Next a control system of the vehicle may send instructions to a parcel handling device. The handling device may deliver a parcel to the user or a message like “Please open parcel compartment” may show up on the screen. The user then may receive the parcel from the handling device or open a door of the parcel compartment to get it.

It may be designed that before delivering a parcel to a user, a vehicle's control system may verify a code or confirm the user's identity. For instance, a user may key in a numerical code provided by Service Center on a screen of a vehicle or show a bar code or quick response (QR) code, which may be displayed on a screen of a smartphone, to a scanner of the vehicle. Service Center may send a code to a user in a confirmation email or message. Once a code, bar code, or QR code is verified, the control system may release a parcel. The control system may also take a picture of a user and conduct facial recognition to confirm the user's identity. After determining that the user is the recipient, the control system may send instructions to release a parcel.

Besides voice input, a tapping act may also be replaced by gesture instructions. When a device or a vehicle is equipped with a gesture sensor and gesture recognition mechanism, a user may gesture to choose and activate a button. Voice and gesture methods may be especially useful for VR and AR devices, as their screen is either virtual or too small to tap on it.

In embodiments depicted above, besides presenting a message or notification on a display of a vehicle, a control system of the vehicle may also use a speaker to make an audible message or notice to inform a user inside the vehicle. In some cases, the two presentation modes (i.e., visual and audio modes) may be implemented to present a message at the same time. Optionally, the two modes may be implemented separately.

Furthermore, when Service Center schedules a user to ride in a vehicle with another user in a shared-vehicle case, the center actually arranges two strangers to meet each other “naturally”. Thus, a vehicle may also be configured to become a meet-new-friends platform or match-making platform and provide a meet-new-friends service. The term “new friend” as used herein may indicate a person who is a stranger to a user and may or may not become a friend of the user in the future. Before a user requests the service, the user may register at Service center, enroll in a meet-new-friends program, and provide certain personal info at Service Center. The personal info may include a user's profile, background, and preferences for a new friend. For instance, an icon may be configured in an interface of a vehicle-hailing app, such as Car App. The icon may have a label such as “Meet New Friends”. A user may tap the icon to enter an enrollment page, provide required info, and submit application for enrollment. After the application is approved by Service Center, the user may join the meet-new-friends program. When a user is in the meet-new-friends program, Service Center may select a suitable co-occupant for the user after the user hails a shared vehicle. It is assumed that the co-occupant is also enrolled in the meet-new-friends program. As a suitable co-occupant may not be available in many occasions, the other occupant in a vehicle may not be the one who enrolls in the program. Thus a user doesn't know whether or not the other occupant wants to start a relationship. Hence for a user enrolled in the meet-new-friends program, sharing a vehicle may remain as a neutral, natural and regular event without anxiety, pressure, and any burden.

After Service Center receives a request for a shared vehicle from a user, the center may check whether the user enrolls in a program for meeting new friends. If the answer is yes, the center may perform a matching process to pair the user with another requester. The match-making process may include several steps. The center may screen all shared vehicle requesters to select some whose route is close to the user's route. Then the center may screen the selected requesters one more time to get a list of candidates who also participate in the program and are willing to meet new friends. Next the center may retrieve personal info of the user and the candidates from a database at Service Center. The center may compare and analyze the data. If there is a match, i.e., one of the candidates fits conditions set forth by the user and vice versa, the center may assign a vehicle to both parties and send them confirmation messages respectively. Then the two parties may have a chance to meet each other and share a vehicle for some time on a trip. The conditions may include preferences of each party and certain requirements defined by Service Center. If there is no good match or a suitable co-occupant is unavailable, the center may pick another requester randomly based on route requirements only and send respective messages to both parties. In either case, a requester doesn't know whether the other occupant is enrolled in the meet-new-friends program. Thus a requester may treat the other occupant as an ordinary occupant and take a shared ride naturally and comfortably.

If a user likes the other occupant, the user may start a conversation. The user may also send a request to Service Center and request to contact the other occupant. If the other occupant allows messaging between occupants, which may be arranged as an optional item of the meet-new-friends program, a message may be sent to the other occupant along with info about the user. If the other occupant doesn't allow messaging between occupants, the user's request may be declined. Thus if a user doesn't want to be bothered by electronic messages from strangers or face an awkward situation when the two meet again afterwards and still wants to meet new friends, the user may check a box with a label like “No Messaging”. The box may be configured in an interface of the meet-new-friends program. After Service Center receives info that the box is checked by a user, messaging from other occupants to the user may be blocked.

Moreover, another option may be provided to a user enrolled in the meet-new-friends program. The option may be designed to allow Service Center to choose a route which may be longer than an optimized route by a given percentage, say twenty percent. For instance, after a user submits a request for a shared vehicle, Service Center finds out that the user is enrolled in the meet-new-friends program. Then Service Center may calculate an optimized route and a proposed route for the user. The optimized route may be calculated in a normal way, that is, without considering whether the other occupant is a good match for the user. First, Service Center may get routes of every requester of shared vehicle. Then the center may compare all routes obtained and find whether there is a route which matches the user's route to a certain extent. If there is one, Service Center may calculate a route based on routes of the user and the other requester. The calculated route may be referred to as the optimized route that satisfies needs of both parties without consideration of the meet-new-friends program. Since the user is enrolled in the meet-new-friends program, Service Center may find another requester who is also in the program and the two are a good match to each other in terms of preferences and other predetermined factors. Assuming that the other requester's route is farther away relatively. Then Service Center may calculate a proposed route. The proposed route may be longer than the optimized route and thus costs more or takes more time for the user. If the length of the proposed route is not longer than a given value, for instance, twenty percent of the length of the optimized route, Service Center may pair the two together and arrange them to share a vehicle. If the length of the proposed route is longer than the given value, Service Center may discard the route and search for another qualified requester. Service Center may also give up and select a requester not in the program if there is no good match. Since a proposed route may allow a user to have more chances to meet other users, users in the program may have incentive to spend more money and time to take it. Again, a check box may be configured in an interface of the program. A note like “Authorization for Longer Trip” may be placed beside a check box. If a user checks the box, an authorization is submitted and Service Center may arrange a route which is longer than an optimized journey. If a user doesn't check the box, the length increase of a proposed route may be maintained below a smaller value, say five percent. As a route of a shared vehicle may change each time, a user may not know whether it is an optimized route or proposed route. Thus the user doesn't know whether or not the other occupant is in the meet-new-friends program and may remain in a natural and easygoing state.

Lastly, it may also be designed that when a user taps button 98 of FIG. 2, another interface appears. The new interface may contain several check boxes as options provided for an occupant of a shared vehicle. For instance, one check box may have a description sentence “Same Gender Only”, which may mean a user requires that another occupant or the other occupants of a vehicle must be the same gender. And another check box may have a description sentence “Frequent Rider Only”, which may mean that a user requires that another occupant or the other occupants must qualify as a frequent rider at Service Center. Service Center may define a frequent rider as someone who hails a vehicle at least a given times a month for a given period of time such as six months. The options may benefit certain users who want to take precautions to lower safety risks, especially when a user hails a vehicle after dark. It is noted that a user may have to register at Service Center and submit own gender info in order to be allowed to select the gender requirement option.

Therefore the scope of the invention should be determined by the appended claims and their legal equivalents, rather than by the examples given.

What is claimed is:

1. A method for hailing or reserving a vehicle via an electronic device, the electronic device having a display, the method comprising:
presenting content items in an interface of the display after a first person opens a hailing and reservation program at the electronic device;
communicating with a service facility;
presenting an interactive element for vehicle hailing in the interface;
presenting a gender option in the interface for the first person to select, the gender option arranged for a same gender request regarding a second person in the vehicle, the same gender request requesting that gender of the second person is same as gender of the first person;
sending the service facility a request message for vehicle hailing in response to activation of the interactive element by the first person; and
sending the service facility the same gender request when the gender option is selected by the first person.

2. The method according to claim 1 further including obtaining gender information of the first person.

3. The method according to claim 1 further including presenting a graphic object in the interface for the first person to select the gender option.

4. The method according to claim 1, wherein the gender option is further arranged for lowering safety risks for the first person.

5. The method according to claim 1 further including receiving destination information after the first person submits the destination information via the interface.

6. The method according to claim 1 further including presenting cost information to the first person.

7. The method according to claim 1 further including sending the service facility the request message after a voice command for vehicle hailing is received via voice recognition.

8. A method for hailing or reserving a vehicle via an electronic device, the electronic device having a display, the method comprising:
presenting content items in an interface of the display after a first person opens a hailing and reservation program at the electronic device;
communicating with a service facility;
presenting an interactive element for vehicle hailing in the interface;
presenting a gender option in the interface for the first person to select, the gender option arranged for a same gender request regarding a second person in the vehicle, the same gender request requesting that gender of the second person is same as gender of the first person; and
sending the service facility a request message for vehicle hailing in response to activation of the interactive element by the first person.

9. The method according to claim 8 further including obtaining gender information of the first person.

10. The method according to claim 8 further including presenting a graphic object in the interface for the first person to select the gender option.

11. The method according to claim 8, wherein the gender option is further arranged for lowering safety risks for the first person.

12. The method according to claim 8 further including receiving destination information after the first person submits the destination information via the interface.

13. The method according to claim 8 further including presenting cost information to the first person.

14. The method according to claim 8 further including sending the service facility the request message after a voice command for vehicle hailing is received via voice recognition.

15. A method for processing a request for vehicle hailing from a first person, comprising:
obtaining data of a current location of the first person from a device of the first person or a service facility;
obtaining data of destination from the first person;
obtaining the request for vehicle hailing from the first person;
determining whether a gender option is selected by the first person, the gender option arranged for a same gender request;
after it is determined that the gender option is selected by the first person, selecting a vehicle for the first person, wherein gender of a second person in the vehicle is same as gender of the first person, and the same gender request requests that the gender of the second person is same as the gender of the first person; and
dispatching the vehicle to pick up the first person.

16. The method according to claim 15 further including obtaining gender information of the first person.

17. The method according to claim 15, wherein the gender option is arranged for lowering safety risks for the first person.
